(19) United States
(12) Patent Application Publication
(10) Pub. No.: US 2021/0276897 A1
(43) Pub. Date: Sep. 9, 2021

(54) In-house closed water filter system to remove carcinogenic 1,4-dioxane and other contaminants to purify drinking water

(71) Applicants: ARYA BHUSHAN, St. Louis, MO (US); PREETI MISRA, St. Louis, MO (US)

(72) Inventors: ARYA BHUSHAN, St. Louis, MO (US); PREETI MISRA, St. Louis, MO (US)

(21) Appl. No.: 17/120,205

(22) Filed: Dec. 13, 2020

(51) Int. Cl. C02F 1/72; C02F 1/32; C02F 1/28

(52) U.S. Cl. CPC C02F 1/725; C02F 1/722; C02F 1/325; C02F 2101/34; C02F 2305/026; C02F 2305/10; C02F 2303/04; C02F 1/283

(57) ABSTRACT

An in-house closed water filter system to remove carcinogenic 1,4-dioxane and other contaminants to purify drinking water. A resin is engineered by a method developed to identify 1,4-dioxane and remove it using direct photolysis and advanced oxidation processes involving UV/H₂O₂/Fe(II). The resin is coupled with granulated activated charcoal to create an in-house filter system.

Current invention is directed to an in-house closed water filter system to remove carcinogenic 1,4-dioxane and other contaminants to purify drinking water.

### BACKGROUND

1,4 Dioxane is a synthetic industrial chemical that is completely miscible in water. It is a by-product present in many goods, including paint strippers, dyes, greases, antifreeze and aircraft deicing fluids, and in some consumer products (deodorants, shampoos and cosmetics) [1, 2]. 1,4 Dioxane facilitates the dispersal of spent chlorinated solvents into ground and surface water systems, as evidenced by its detection in surface waters throughout >45 states in the US. Short-term exposure to high levels of 1,4-dioxane may result in nausea, drowsiness, headache, and irritation of the eyes, nose and throat [1].

More importantly, long term exposure to 1,4 dioxane can cause cancer. Animal studies showed increased incidences of nasal cavity, liver and gall bladder tumors after exposure to 1,4-dioxane through drinking water [3].

The Environmental Protection Agency (EPA) has classified 1,4-dioxane as “likely to be carcinogenic to humans” by all routes of exposure and the U.S. Department of Health and Human Services states that “1,4-dioxane is reasonably anticipated to be a human carcinogen based on sufficient evidence of carcinogenicity from studies in experimental animals” [4].

Because of its wide use and potential harm, 1,4-dioxane is one of the first 10 chemicals the EPA picked for review under the nation's new chemical safety law. Acute exposure to large amounts of 1,4-dioxane has been shown to cause symptoms of nervous system depression and lesions on the stomach, lungs, liver and kidneys [5]. Although human studies are limited so far, animals studies have shown evidence of carcinogenicity, and comparative studies of exposed workers have shown higher incidences of liver cancer [6].

According to the World Health Organization (WHO), because of its high solubility in water, 1,4-dioxane is not treatable using conventional methods. As a result of the limitations in the analytical methods to detect 1,4-dioxane, it has been difficult to identify its occurrence in the environment. The miscibility of 1,4-dioxane in water causes poor purging efficiency and results in high detection limits [7]. Traditional pump and treatment systems usually employ air stripping as a separation technique and/or adsorption by granular activated carbon (GAC). Ex-situ bioremediation using a fixed-film, moving bed biological treatment system is also used to treat 1,4-dioxane in groundwater [8]. Microbial degradation in engineered bioreactors has been documented under enhanced conditions or where selected strains of bacteria capable of degrading 1,4-dioxane are cultured, but the impact of the presence of chlorinated solvent co-contaminants on biodegradation of 1,4-dioxane needs to be further investigated [9].

Research into adsorption/desorption media has identified using synthetic resins (e.g., AMBERSORB™ 560) as a viable treatment alternative to GAC for ex-situ treatment of 1,4-dioxane [10] but requires disposal or regeneration and waste stream disposal. Neither of these techniques are very effective in removing 1,4-dioxane from water [11]. In addition, these media are for commercial use only, usually costing upwards of $90,000. Although 1,4 dioxane is one of the first 10 chemicals the EPA picked for review under the nation's new chemical safety law, the review could take years as the agency has failed to set standards for any new drinking water contaminant in more than 20 years. Unfortunately, many conventional water treatment options and most in-home water filters do not remove 1,4-dioxane effectively due to its low vapor pressure and high solubility.

Groundwater can be treated ex-situ using modified Fenton's reagent, ultraviolet/peroxide, ozone/peroxide, or sodium persulfate, collectively referred to as advanced oxidation processes (AOPs) [12]. These treatments are also effective for addressing chlorinated volatile organics (CVOCs) that are often found with 1,4-dioxane, although AOPs might require further optimization when applied to sites with CVOCs and 1,4-dioxane mixtures owing to the different chemical structures and individual affinities for hydroxyl radicals [13]. Comprehensive investigations showed that the Fenton's reagent is effective in treating various industrial wastewater components including aromatic amines, a wide variety of dyes, pesticides, surfactants explosives as well as many other substances [14].

In comparison to other oxidation processes, such as UV/H₂O₂ process, costs of Fenton's oxidation are quite low. Fenton's oxidation has been used for different treatment processes because of its ease of operation, the simple system and the possibility to work in a wide range of temperatures.

### SUMMARY

The invention is directed to develop an in-house closed water filter system to purify drinking water to get rid of harmful chemicals like 1,4-dioxane and other contaminants. In one embodiment, the invention is directed to an initial step to identify 1,4-dioxane using easily available instruments like Gas Chromatography/Mass Spectrometer (GC/MS) and to understand the removal of 1,4-dioxane by direct UV photolysis and advanced oxidation processes involving UV/H₂O₂/Fe(II). This process utilizes the formation of hydroxyl radicals to oxidize contaminants to less harmful forms and provide an aspects to get drinking water which led to free of hazardous chemicals like 1,4-dioxane. In an another embodiment the invention is directed to develop a cartridge for an in-house closed water filter system to purify drinking water and get rid of harmful chemicals like 1,4-dioxane using modified Fenton's oxidation technique. The final goal is to develop in-house drinking water purification system for the removal of carcinogenic 1,4-dioxane and other contaminants

A resin is engineered by a method developed to identify 1,4-dioxane and remove it using direct photolysis and advanced oxidation processes involving UV/H₂O₂/Fe(II). The resin is coupled with granulated activated charcoal to create an in-house filter system. In an embodiment, the invention is directed to an in-house closed water filter system to remove carcinogenic 1,4-dioxane and other contaminants to purify drinking water.

### BRIEF DESCRIPTION OF THE DRAWINGS

FIG. 1 illustrates the in-house closed water filter system to remove carcinogenic 1,4-dioxane and other contaminants to purify drinking water. FIG. 2 illustrates H₂O₂/Fe(II)/UV treatment result in faster 1,4 dioxane degradation kinetics compared to H₂O₂/UV treatment.

### DETAILED DESCRIPTION

For the Fenton's Oxidation, the first step is the oxidation and an analysis of 1,4 dioxane using GC/MS such that to substantially lower 1,4 dioxane concentration in the water. After oxidation and the determination of the lower amount of the 1,4-dioxane concentration, the next step is designing an in-house closed system cartridge to purify water contaminated with 1,4-dioxane.

The in-house closed system use the concept of heterogeneous Fenton's Reaction which utilizes a solid iron oxide bed as a catalyst. To do this, an Iron Oxide is being absorbed on cartridges and then add a sample of water spiked with 1,4-dioxane and H₂O₂ at the same time to get the mixture. The irradiation of the mixture under UV light oxidize the 1,4-Dioxane. The oxidized treated water sample passes through the cartridge containing GAC for removing H₂O₂ [15], [16].

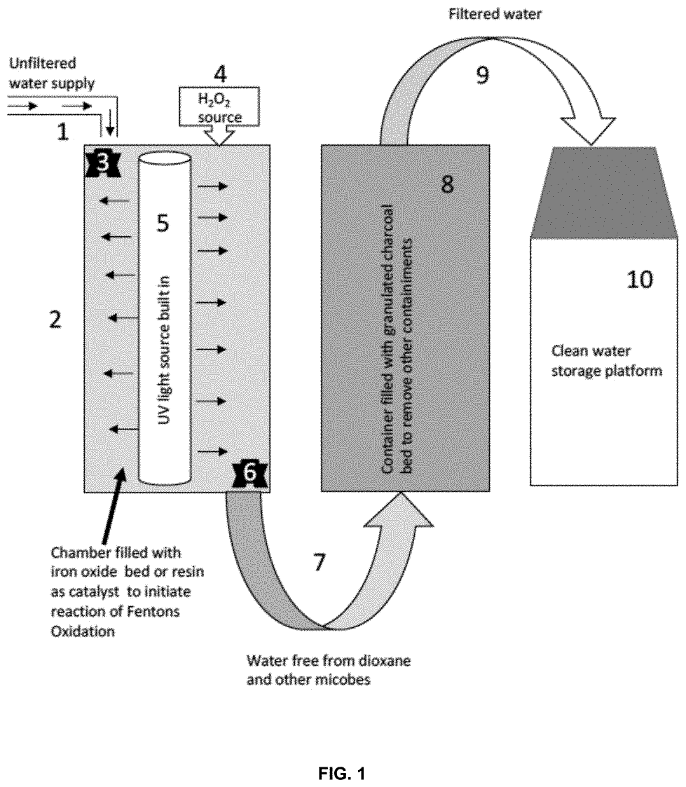

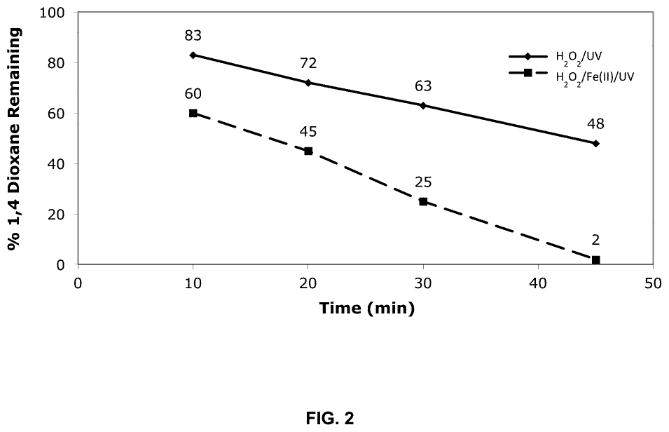

Based on the Fentons's Reaction, a fabrication of a resin based cartridge coupled and installed into an in-house water purification system. FIG. 1 illustrate the in-house closed water filter system to remove carcinogenic 1,4-dioxane and other contaminants to purify drinking water. The in-house closed water filter system contains three units. The inflow of unfiltered tap water supply 1 into the first unit 2 at one end and at another end of 2 the water free from dioxane and other microbes flow out into second unit 8. The first unit 2 is a chamber filled with iron oxide bed or resin which act as catalyst to initiate reaction of Fenton's Oxidation. The first unit 2 contains two sensors. The first sensor 3 is to indicate the filling of the first unit 2 chamber with unfiltered water and activate the initiation of addition of hydrogen peroxide from the H₂O₂ source 4 to the water. The second sensor 6 is to open the flow of the water from the unit 2 after completion of Fenton's Reaction to completely empty the water from unit 2. The sensors 3 and 6 are configured in such a way that after completely empty the water from unit 2 the sensor 6 closes the flow of water out of the unit 2 and sensor 3 initiate the filing of the unit 2 chamber with the unfiltered water to completely fill the unit 2 and activate the initiation of addition of hydrogen peroxide from the H₂O₂ source 4 to the water.

The unit 2 contains inbuilt UV light source 5 which is connected and configured with sensors 3 and 6 to start and stop the Fenton's Reaction. A valve 7 connecting unit 2 with the second unit 8, which transfer purified water after Fenton's Reaction in the first unit 2 to further purification in the second unit 8.

The second unit 8 of the filter system is filled with granulated charcoal bed to remove remaining hydrogen peroxide residue and other contaminants from water. A valve 9 connecting second unit 8 with the third unit 10, which transfer final purified water to the third unit 10. The clean water stored in third unit 10 is served as clean water storage platform to use for drinking.

The oxidation of the 1,4-dioxane is optimized to its lowest concentration. The synthetic water samples spiked with 1,4-dioxane at several concentrations is selected. The concentration of 1,4-dioxane selected in the range of from about 2 ppm to about 100 ppm, from about 2 ppm to about 50 ppm, preferably, from about 2 ppm to about 40 ppm, and more preferably from about 2 ppm to about 25 ppm. The samples are oxidized and irradiated for time interval using H₂O₂/UV and H₂O₂/Fe(II)/UV a heterogeneous Fenton's Reaction chemistry. The irradiation time is from about 2 min to about 45 min, from about 2 min to about 30 min, preferably from about 2 min to about 25 min, and more preferably from about 2 min to about 15 min. The concentration of H₂O₂ is from about 2 mg/l to about 100 mg/l, from about 2 mg/l to about 80 mg/l, preferably from about 10 mg/l to about 50 mg/l, more preferably from about 10 mg/l to about 25 mg/l. The concentration of Fe(II) is from about 2 mg/l to about 100 mg/l, from about 2 mg/l to about 80 mg/l, preferably from about 5 mg/l to about 50 mg/l, more preferably from about 10 mg/l to about 25 mg/l. The UV light source is up to 54 W (115-220 v), preferably-25 W (115-220 v), more preferably 4 to 15 W (115-220 v).

1 mL sample is taken at set time point during the irradiation for analysis and analysis is performed using GC/MS. The direct UV irradiation results in little to no degradation of 1,4-dioxane. H₂O₂/UV treatments and H₂O₂/Fe(II)/UV all results in 1,4-dioxane degrading in the water samples. H₂O₂/Fe(II)/UV treatment results in faster degradation kinetics compared to H₂O₂/UV treatment and thus the designing of the resin based on the heterogeneous Fenton's reaction.

The units 2, 8, and 10 have a capacity of carrying from about 2 to about 50 liter water, from about 2 to about 40 liter water, from about 2 to about 25 liter water, from about 15 to about 30 liter water, preferably from about 5 to about 20, and more preferably, from about 10 to about 20 liter water. In the unit 2, the chamber of iron oxide bed or resin has capacity of carrying iron oxide in an amount of from about 10 g to about 1000 g, from about 10 g to about 500 g, from about 10 g to about 300 g, preferably from about 15 g to about 200 g, more preferably from about 20 g to about 150 g.

In an embodiment, first step is performed for the oxidation and the sample analyzed for the 1,4-dioxane using easily available instruments like GC/MS. In order to perform an experiment, synthetic water samples spiked with 1,4-Dioxane at a concentration of 50 ppm are prepared. The samples are oxidized and radiated for 10 to 45 minutes using H₂O₂/UV and H₂O₂/Fe(II)/UV. Then, 1.0 mL samples are taken at set time points during the radiation for analysis. All the samples are analyzed through GC/MS. Direct UV irradiation result shows in little to no degradation of 1,4-Dioxane. H₂O₂/UV treatments and H₂O₂/Fe(II)/UV all result in 1,4-dioxane degrading in the water samples. H₂O₂/Fe(II)/UV treatment result in faster degradation kinetics compared to H₂O₂/UV treatment (FIG. 2).

### References

1. Agency for Toxic Substances and Disease Registry (ATSDR), Public Health Statement for 1,4 Dioxane, April 2012, CAS# 123-91-1

2. Zhou W. The determination of 1,4-dioxane in cosmetic products by gas chromatography with tandem mass spectrometry. J Chromatogr A. 2019 Dec 6;1607:460400. doi: 10.1016/j.chroma.2019.460400. Epub 2019 Jul. 26.

3. U.S. Department of Health and Human Services (DHHS), Report on Carcinogens, Twelfth Edition. Public Health Service, National Toxicology Program, 2014, 13th Edition. ntp.niehs.nih.gov/ntp/roc/content/profiles/dioxane

4. U.S. Environmental Protection Agency, Integrated Risk Information System (IRIS), Chemical Assessment Summary 1,4-Dioxane, 2013, CASRN 123-91-1

5. Godrie Krystal J. G et. al. 1,4-Dioxane as an emerging water contaminant: State of the science and evaluation of research needs, Science of The Total Environment, 2019, 690, 853-866.

6. Dourson et. al. Update: Mode of action (MOA) for liver tumors induced by oral exposure to 1,4-dioxane: Regul Toxicol Pharmacol., 2017, 88, 45-55.

7. EPA 2006, “Treatment Technologies for 1,4-Dioxane: Fundamentals and Field Applications.” EPA 542-R-06-009.

8. Mahendra, S., Grostern, A., and Alvarez-Cohen, L., The Impact of Chlorinated Solvent CoContaminants on the Biodegradation Kinetics of 1,4-Dioxane, Chemosphere., 2013, 91 (1), 88-92

9. DiGuiseppi, W. et al., 1,4-Dioxane treatment technologies, Remediation Journal, 2016, 27(1), 71-92

10. Suthersan, S. et al., Making strides in the management of “emerging contaminants,” Groundwater Monitoring & Remediation, 2016, 36(1), 15-25

11. Mohr, T. K. G. et al., Environmental Investigation and Remediation: 1,4-Dioxane and Other Solvent Stabilizers. CRC Press, Boca Raton, Fla., 2010

12. Zhang, S. et al., Advances in bioremediation of 1,4-dioxane-contaminated waters, Journal of Environmental Management, 2017, 204(2), 765-774

13. Amiri et.al. The Use of Iron in Advanced Oxidation Processes, Journal of Advanced Oxidation Technologies, Published Online: 2017-01-26|DOI: https://doi.org/10.1515/jaots-1996-0105

14. Aguinaco, A., Decomposition of hydrogen peroxide in the presence of activated carbons with different characteristics, Chemical Technology & Biotechnology, 2011, 86, 595-600

15. Zhang, H. et. al., Removal of COD from landfill leachate by electro-fenton method Journal of Hazardous Materials, 2006, 1-3, 106-111

16. Zhang, H. et al. Optimization of Fenton process for the treatment of landfill lechate, Journal of Hazardous Material, 2005, 1-3, 166-174

What is claimed is:

1. An in-house drinking water purification system comprising:
a first unit, wherein the first unit having a top and a bottom opening, wherein the top opening allows an unfiltered water to fill the first unit and the bottom unit allows a flow of water free from 1,4-dioxane and microbes out of the first unit,
a second unit, wherein the second unit is connected to the first unit by a first valve, wherein the first valve allows the flow of water free from 1,4-dioxane and microbes from the first unit to the second unit, and
a third unit, wherein the third unit is connected to the second unit by a second valve, wherein the second valve allows a flow of purified water from the second unit to the third unit.

2. The in-house drinking water purification system of claim 1, wherein the first unit contains a chamber filled with iron oxide bed or resin which act as catalyst to initiate reaction of Fenton's Oxidation to remove the 1,4-dioxane and micobes.

3. The in-house drinking water purification system of claim 2, wherein the first unit contains a first sensor and a second sensor, wherein the first sensor is to indicate the filling of the chamber with the unfiltered water and activate an initiation of addition of hydrogen peroxide from a hydrogen peroxide source in the first unit.

4. The in-house drinking water purification system of claim 3, wherein the second sensor opens the flow of water from the first unit after completion of the Fenton's Oxidation to completely empty water from the first unit.

5. The in-house drinking water purification system of claim 4, the first sensor and the second sensor are configured such that after completely empty water from first unit, the second sensor closes the flow of water out of the first unit and first sensor initiate the filing of the chamber in the first unit with the unfiltered water to completely fill the first unit and activate the initiation of addition of hydrogen peroxide from the hydrogen peroxide source.

6. The in-house drinking water purification system of claim 3, wherein the first unit contains an inbuilt UV light source, wherein the inbuilt UV light source is connected and configured with first sensor and the second sensor to start and stop the Fenton's Oxidation, wherein the first valve allows the flow of water free from 1,4-dioxane and microbes from the first unit to the second unit after the Fenton's Oxidation.

7. The in-house drinking water purification system of claim 6, wherein the second unit is filled with a granulated charcoal bed to remove a remaining hydrogen peroxide residue and other contaminants from water, wherein the second valve allows the flow of purified water from the second unit to the third unit, wherein the third unit is served as clean water storage platform to use for drinking.

8. A method of making an in-house drinking water purification system, wherein the method comprising:
providing a first unit, wherein the first unit having a top and a bottom opening, wherein the top opening allows an unfiltered water to fill the first unit and the bottom unit allows a flow of water free from 1,4-dioxane and microbes out of the first unit,
connecting the first unit to a second unit by a first valve, wherein the first valve allows the flow of water free from 1,4-dioxane and microbes from the first unit to the second unit, and
connecting the second unit to a third unit by a second valve, wherein the second valve allows a flow of purified water from the second unit to the third unit.

9. The method of claim 8, wherein the first unit contains a chamber filled with iron oxide bed or resin which act as catalyst to initiate reaction of Fenton's Oxidation to remove the 1,4-dioxane and micobes.

10. The method of claim 9, wherein the first unit contains a first sensor and a second sensor, wherein the first sensor is to indicate the filling of the chamber with the unfiltered water and activate an initiation of addition of hydrogen peroxide from a hydrogen peroxide source in the first unit.

11. The method of claim 10, wherein the second sensor opens the flow of water from the first unit after completion of the Fenton's Oxidation to completely empty water from the first unit.

12. The method of claim 11, the first sensor and the second sensor are configured such that after completely empty water from first unit, the second sensor closes the flow of water out of the first unit and first sensor initiate the filing of the chamber in the first unit with the unfiltered water to completely fill the first unit and activate the initiation of addition of hydrogen peroxide from the hydrogen peroxide source.

13. The method of claim 10, wherein the first unit contains an inbuilt UV light source, wherein the inbuilt UV light source is connected and configured with first sensor and the second sensor to start and stop the Fenton's Oxidation, wherein the first valve allows the flow of water free from 1,4-dioxane and microbes from the first unit to the second unit after the Fenton's Oxidation.

14. The method of claim 13, wherein the second unit is filled with a granulated charcoal bed to remove a remaining hydrogen peroxide residue and other contaminants from water, wherein the second valve allows the flow of purified water from the second unit to the third unit, wherein the third unit is served as clean water storage platform to use for drinking.

15. A method of using an in-house drinking water purification system, wherein the method comprising:
providing the in-house drinking water purification system, wherein the in-house drinking water purification system comprising:
a first unit, wherein the first unit having a top and a bottom opening, wherein the top opening allows an unfiltered water to fill the first unit and the bottom unit allows a flow of water free from 1,4-dioxane and microbes out of the first unit,
a second unit, wherein the second unit is connected to the first unit by a first valve, wherein the first valve allows the flow of water free from 1,4-dioxane and microbes from the first unit to the second unit, and
a third unit, wherein the third unit is connected to the second unit by a second valve, wherein the second valve allows a flow of purified water from the second unit to the third unit,
activating a first sensor and a second sensor in the first unit, and
purifying the unfiltered water to obtain purified drinking water.

16. The method of claim 15, wherein the first unit contains a chamber filled with iron oxide bed or resin which act as catalyst to initiate reaction of Fenton's Oxidation to remove the 1,4-dioxane and micobes.

17. The method of claim 16, wherein the first sensor is to indicate the filling of the chamber with the unfiltered water and activate an initiation of addition of hydrogen peroxide from a hydrogen peroxide source in the first unit.

18. The method of claim 17, wherein the second sensor opens the flow of water from the first unit after completion of the Fenton's Oxidation to completely empty water from the first unit.

19. The method of claim 18, the first sensor and the second sensor are configured such that after completely empty water from first unit, the second sensor closes the flow of water out of the first unit and first sensor initiate the filing of the chamber in the first unit with the unfiltered water to completely fill the first unit and activate the initiation of addition of hydrogen peroxide from the hydrogen peroxide source.

20. The method of claim 19, wherein the first unit contains an inbuilt UV light source, wherein the inbuilt UV light source is connected and configured with first sensor and the second sensor to start and stop the Fenton's Oxidation, wherein the first valve allows the flow of water free from 1,4-dioxane and microbes from the first unit to the second unit after the Fenton's Oxidation, wherein the second unit is filled with a granulated charcoal bed to remove a remaining hydrogen peroxide residue and other contaminants from water, wherein the second valve allows the flow of purified water from the second unit to the third unit, wherein the third unit is served as clean water storage platform to use for drinking.
